(19) United States
(12) Patent Application Publication
(10) Pub. No.: US 2025/0299651 A1
(43) Pub. Date: Sep. 25, 2025

(54) KEYBOARD INSTRUMENT AND METHOD OF PRODUCING KEY OF KEYBOARD INSTRUMENT

(71) Applicant: YAMAHA CORPORATION, Hamamatsu-shi (JP)

(72) Inventors: Ichiro OSUGA, Hamamatsu-shi (JP); Kazuki SOGA, Hamamatsu-shi (JP); Yoshiyuki HIRAI, Hamamatsu-shi (JP); YUJI TAKAHASHI, Hamamatsu-shi (JP); Yoshihiro KATSUMATA, Hamamatsu-shi (JP)

(21) Appl. No.: 19/228,923

(22) Filed: Jun. 5, 2025

Related U.S. Application Data
(63) Continuation of application No. PCT/JP2023/031210, filed on Aug. 29, 2023.

(30) Foreign Application Priority Data
Dec. 19, 2022 (JP) 2022-202486

(51) Int. Cl. G10C 3/12; G10C 1/02; G10C 9/00; G10H 1/34

(52) U.S. Cl. CPC G10C 3/125; G10C 1/02; G10C 9/00; G10H 1/344

(57) ABSTRACT

A keyboard instrument includes keys containing a woody material and including natural note keys and accidental note keys. Each natural note key includes a first playing surface played to produce a natural note. Each accidental note key includes a second playing surface played to produce an accidental note. The first playing surface has a first colorimetric value representing a first color, and the second playing surface color has a second colorimetric value representing a second color. Each of the first and second colorimetric values is derived in accordance with an SCI method in an L*a*b* color space. The first and second colorimetric values satisfy at least one of: a first condition: ΔE*ab≤17, or a second condition: ΔH*<15 and −1.7<L*/c*<1.7. The first and second playing surfaces differ from each other in at least one of optical reflectance or surface roughness.

### CROSS-REFERENCE TO RELATED APPLICATIONS

The present application is a continuation application of International Application No. PCT/JP2023/031210, filed Aug. 29, 2023, which claims priority to Japanese Patent Application No. 2022-202486, filed Dec. 19, 2022. The contents of these applications are incorporated herein by reference in their entirety . . .

### BACKGROUND

The present disclosure relates to a keyboard instrument and a method of producing a key of a keyboard instrument.

Various technologies have been proposed in the past with regard to the keys of keyboard instruments, for example, pianos. For example, JP 2011-242792 A discloses a technology for molding a material containing dyed wood powder, resin, and pigment into black keys of a keyboard instrument.

The keyboard of a keyboard instrument has a structure in which a plurality of white keys and a plurality of black keys are arranged. The structure described above is a well-known design, and has room for improvement from various perspectives, for example, a sense of color consistency. In view of the circumstances described above, an object of one aspect of the present disclosure is to provide an aesthetically excellent design for a keyboard instrument.

### SUMMARY

One aspect is a keyboard instrument includes a plurality of keys. The plurality of keys contain a woody material, and include a plurality of natural note keys and a plurality of accidental note keys. Each of the plurality of natural note keys includes a first playing surface configured to be played to produce a natural note. Each of the plurality of accidental note keys includes a second playing surface configured to be played to produce an accidental note. The first playing surface has a first colorimetric value representing a first color, and the second playing surface color has a second colorimetric value representing a second color. Each of the first and second colorimetric values is derived in accordance with a specular component included (SCI) method in an L*a*b* color space. The first colorimetric value of the first playing surface and the second colorimetric value of the second playing surface satisfy at least one of: a first condition: ΔE*ab≤17, or a second condition: ΔH*<15 and −1.7<L*/c*<1.7, where ΔE*ab represents a color difference between the first color and the second color, ΔH* represents a hue difference between the first color and the second color, and L*/c* represents WL/{(Wa²+Wb²)^{1/2}}, or BL/{(Ba²+Bb²) ^{1/2}}, where WL, Wa, and Wb represent color tone values of the plurality of natural note keys, and BL, Ba, and Bb represent color tone values of the plurality of accidental note keys. The first playing surface and the second playing surface differ from each other in at least one of optical reflectance or surface roughness.

Another aspect is a method of producing a key of a keyboard instrument. The method includes forming a molded body from a composite material containing a woody material and a plastic material. The method also includes removing a portion of a molded surface of the molded body to form a playing surface of the key. The playing surface is for a player to come into contact with to produce a musical note.

A more complete appreciation of the present disclosure and many of the attendant advantages thereof will be readily obtained as the same becomes better understood by reference to the following detailed description when considered in connection with the following figures.

### BRIEF DESCRIPTION OF THE DRAWINGS

FIG. 1 is a perspective view of a keyboard instrument according to a first embodiment.

FIG. 2 is a block diagram showing an example of the internal configuration of the keyboard instrument.

FIG. 3 is an enlarged plan view of a portion of a keyboard.

FIG. 4 is a front view of the keyboard.

FIG. 5 is a side view of a natural note key.

FIG. 6 is a side view of a key assembly.

FIG. 7 is an enlarged plan view of an attachment portion and the vicinity thereof, the attachment portion corresponding to each of the keys.

FIG. 8 is a flowchart of a step of producing the natural note key.

FIG. 9 is a flowchart of a step of producing an accidental note key.

FIG. 10 is a plan view of a natural note key unit.

FIG. 11 is a plan view of an accidental note key unit.

### DETAILED DESCRIPTION

The present specification is applicable to a keyboard instrument and a method of producing a key of a keyboard instrument.

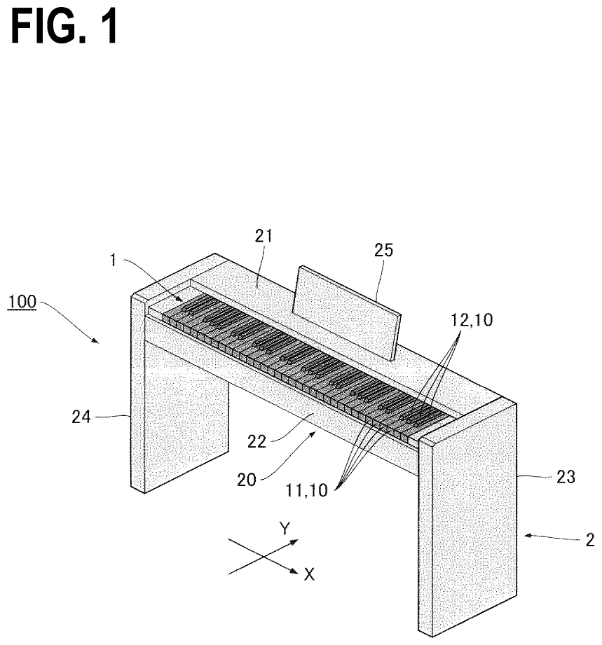

FIG. 1 is a perspective view of a keyboard instrument 100 according to a first embodiment. The keyboard instrument 100 is an electronic musical instrument that emits musical notes in response to a player's playing. The keyboard instrument 100 according to the first embodiment is an electronic piano including a keyboard 1 and a support 2.

The keyboard 1 includes a plurality of keys 10 corresponding to different pitches. The keys 10 are each a playing operator that accepts key pressing and key releasing operations performed by the player. That is, the player sequentially touches keys 10 to produce musical notes having desired pitches. The plurality of keys 10 are arranged along an X-axis. The X-axis is an axis extending rightward and leftward of the player. The Y-axis in FIG. 1 is an axis perpendicular to the X-axis in a horizontal plane. That is, the Y-axis extends frontward and rearward of the player. Each of the keys 10 is a member elongated in the Y-axis direction.

The plurality of keys 10, which constitute the keyboard 1, are grouped into a plurality of natural note keys 11 and a plurality of accidental note keys 12. That is, the keyboard 1 is formed of the plurality of natural note keys 11 and the plurality of accidental note keys 12. Each of the natural note keys 11 is a key corresponding to a natural note, and each of the accidental note keys 12 is a key corresponding to an accidental note. The natural notes are the basic musical notes on the musical scale, specifically, refer to the musical notes (C, D, E, F, G, A, and B) to which accidentals such as sharp or flat are not added. The natural note keys 11 correspond to white keys (long keys) of a typical black-and-white keyboard. The accidental notes are musical notes other than the natural notes on the musical scale, specifically, musical notes to which accidentals are added (C sharp, D sharp, F sharp, G sharp, and A sharp). The accidental note keys 12 correspond to black keys (short keys) of a typical black-and-white keyboard.

The support 2 is a structure that houses and supports the keyboard 1. The support 2 in the first embodiment includes an enclosure 20, a right leg 23, a left leg 24, and a music stand 25. The enclosure 20 is a hollow structure that houses and supports the keyboard 1. The enclosure 20 in the first embodiment includes an upper member 21 and a lower member 22. The upper member 21 is a member that constitutes the top surface of the enclosure 20. The lower member 22 is a member that constitutes the bottom surface of the enclosure 20.

Each of the right leg 23 and the left leg 24 is a flat-plate-shaped structure that supports the keyboard 1 and the enclosure 20 at a predetermined height. The enclosure 20 is supported between the right leg 23 and the left leg 24, and the enclosure 20 houses the keyboard 1. The music stand 25 is disposed at the upper member 21 and supports music scores. Note that the right leg 23, the left leg 24 and the music stand 25 may be omitted.

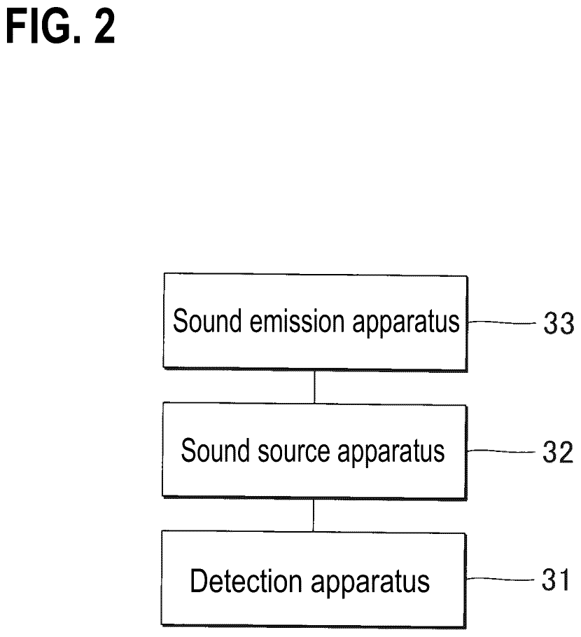

FIG. 2 is a block diagram of the internal configuration of the keyboard instrument 100. The keyboard instrument 100 includes a detection apparatus 31, a sound source apparatus 32, and a sound emission apparatus 33, as shown in FIG. 2. The detection apparatus 31, the sound source apparatus 32, and the sound emission apparatus 33 are housed in the enclosure 20.

The detection apparatus 31 is a sensor that detects an operation performed on any of the plurality of keys 10. Specifically, the detection apparatus 31 detects the player's operation of pressing any of the keys 10 (that is, key pressing operation) and the player's operation of releasing the key (that is, key releasing operation). The detection apparatus 31 is formed, for example, of a sensor that optically, mechanically, or magnetically detects displacement of any of the keys 10.

The sound source apparatus 32 generates an acoustic signal according to the player's playing. The acoustic signal is a signal representing a musical note having a pitch corresponding to a key 10 operated by the player. The sound source apparatus 32 may be either a software sound source realized by a general-purpose arithmetic processor, or a hardware sound source realized by a dedicated electronic circuit.

The sound emission apparatus 33 emits the musical sound indicated by the acoustic signal. For example, one or more loudspeakers are used as the sound emission apparatus 33. Note that a pair of headphones worn on the player's head may be used as the sound emission apparatus 33.

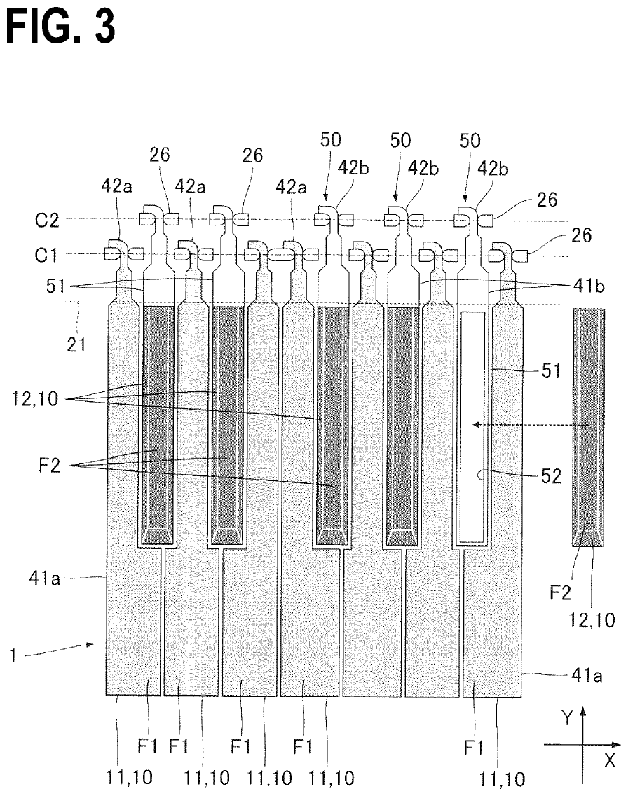

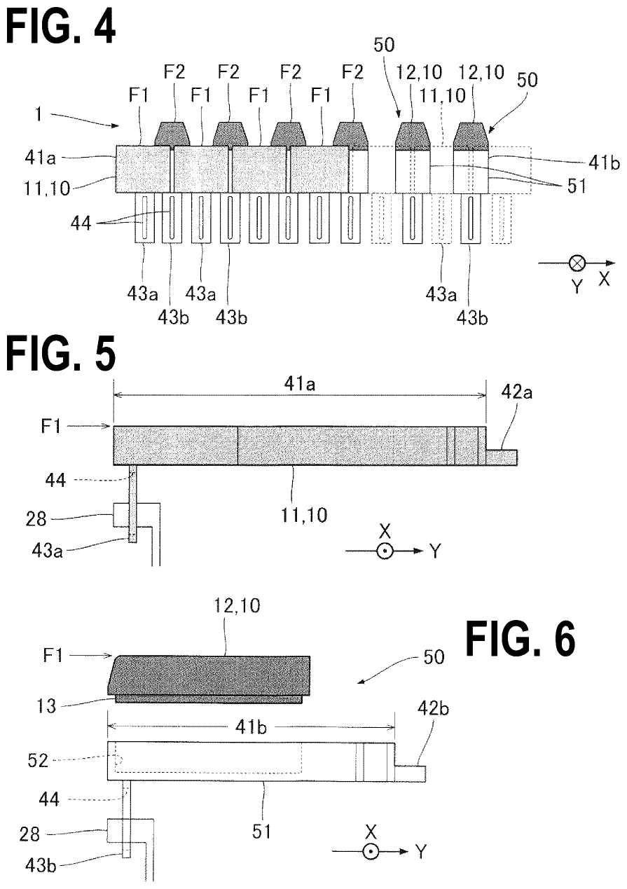

FIG. 3 is an enlarged plan view of a portion of the keyboard 1. FIG. 4 is a front view of the keyboard 1 viewed in the Y-axis direction. Note in FIG. 4 that the outlines of some of the plurality of natural note keys 11 are drawn with dashed lines.

Each of the natural note keys 11 has a first playing surface F1 played to produce a natural note. Similarly, each of the accidental note keys 12 has a second playing surface F2 played to produce an accidental note. The first playing surface F1 and the second playing surface F2 are upper surfaces with which the player's fingers come into contact.

A typical keyboard of related art is formed of white keys and black keys that significantly differ from each other in color. In contrast to the keyboards of related art, the colors of the natural note keys 11 and the accidental note keys 12 are similar to each other in the first embodiment. Specifically, the natural note keys 11 and the accidental note keys 12 are both approximately black in color.

For example, the color difference between the first playing surfaces F1 of the natural note keys 11 and the second playing surfaces F2 of the accidental note keys 12 satisfies ΔE*ab≤17, more specifically, ΔE*ab≤12, where ΔE represents the color difference in the form of a colorimetric value measured based on the SCI (specular component included) method specified by the CIE (International Commission on Illumination) in the L*a*b* color space. The measured colorimetric values described above are values measured by using a CM-700d spectrophotometer manufactured by Konica Minolta, Inc. (registered trademark) and a CIE standard light source D65 under a condition d (di:) 8° using diffused illumination (integrating sphere). In the first embodiment, the above condition for the color difference is satisfied for all of the natural note keys 11 and all of the accidental note keys 12, which constitute the keyboard 1. Note, however, that the condition described above may be satisfied for some of the entire keys 11 and 12, the natural note keys 11 and the accidental note keys 12, which constitute the keyboard 1.

The natural note keys 11 and the accidental note keys 12, however, differ from each other in optical reflectance. The optical reflectance is the ratio (%) of the intensity of light reflected off an object to the intensity of light radiated to the object. Specifically, the optical reflectance of the first playing surfaces F1 differs from the optical reflectance of the second playing surfaces F2. In the first embodiment, the difference in optical reflectance (color difference) between the first playing surfaces F1 and the second playing surfaces F2 satisfies ΔE*ab ≥1, more specifically, ΔE*ab ≥2, where ΔE represents the color difference in the form of a colorimetric value measured based on the SCE (specular component excluded) method specified by the CIE in the L*a*b* color space. The measured colorimetric values described above are values measured by using the CM-700d spectrophotometer manufactured by Konica Minolta, Inc. (registered trademark) and the CIE standard light source D65 under the condition d (di:) 8° using diffused illumination (integrating sphere), as in the colorimetry described above. In the first embodiment, the above condition for the color difference (reflectance difference) is satisfied for all of the natural note keys 11 and all of the accidental note keys 12, which constitute the keyboard 1. Note, however, that the condition described above may be satisfied for some of the entire keys 11 and 12, the natural note keys 11 and the accidental note keys 12, which constitute the keyboard 1.

The color difference ΔE*ab between color tone values (WL, Wa, and Wb) of the natural note keys 11 and color tone values (BL, Ba, and Bb) of the accidental note keys 12 is defined, for example, by the following numerical expression (1): ΔE*ab={(WL-BL) 2+ (Wa-Ba) 2+ (Wb-Bb) 2} 12 (1)

As described above, in the first embodiment, the color difference between the first playing surfaces F1 of the natural note keys 11 and the second playing surfaces F2 of the accidental note keys 12 satisfies ΔE*ab≤17, where ΔE represents the color difference in the form of a colorimetric value measured based on the SCI (specular component included) method specified in the L*a*b* color space. A sense of color consistency is therefore achieved for the entirety of the plurality of keys 10 (that is, keyboard 1) including the plurality of natural note keys 11 and the plurality of accidental note keys 12, so that an aesthetically excellent design can be provided. However, the first playing surfaces F1 and the second playing surfaces F2 differ from each other in optical reflectance, so that the player can visually distinguish the natural note keys 11 and the accidental note keys 12 from each other. That is, the first embodiment can achieve both the sense of color consistency across the keyboard 1 and the distinguishability between the natural note keys 11 and accidental note keys 12.

The plurality of keys 10 are made of a material containing a woody material. The woody material is a material containing woody substances and formed by fragmentation of timber cut from trees. The woody material may be made of, for example, only timber, such as wood powder, or a mixture of timber and a resin material (synthetic resin, for example). For example, the following species of tree are used as the woody material used to form the keys 10: spruce; Yezo spruce; agathis; maple; birch; mansonia; sapele; Australian blackwood; ebony; rosewood; Honduran rosewood; African padauk; grenadilla wood; paulownia; walnut; sonokeling mansonia; ash; ovangkol; olive; or eucalyptus.

Each of the natural note keys 11 is a molded body (that is, injection molded body) formed by injection molding of a composite material that is a mixture of a woody material of a specific species of tree and a plastic material. Each of the accidental note keys 12 is a molded body (that is, flow molded body) formed by flow molding of a woody material of a specific species of tree.

The species of tree of the woody material used to form the natural note keys 11 is identical to the species of tree of the woody material used to form the accidental note keys 11. That is, the first playing surfaces F1 and the second playing surfaces F2 contain a woody material of an identical species of tree. The colors of the natural note keys 11 and the accidental note keys 12 depend on the species of tree of the woody material contained in the material of which the keys are made. That is, in the first embodiment, the material that determines the color of the first playing surfaces F1 of the natural note keys 11 is identical to the material that determines the color of the second playing surfaces F2 of the accidental note keys 12.

As described above, in the first embodiment, the first playing surfaces F1 of the natural note keys 11 and the second playing surfaces F2 of the accidental note keys 12 are made of at least partially an identical material. The present embodiment is therefore advantageous in that the natural note keys 11 and the accidental note keys 12 readily have a unified color, as compared with an embodiment in which the first playing surfaces F1 and the second playing surfaces F2 are made of materials that are not even partially identical. In the first embodiment, in particular, since the material of the first playing surfaces F1 and the material of the second playing surfaces F2 contain a material of the identical species of tree, the first playing surfaces F1 and the second playing surfaces F2 are readily allowed to have colors close to each other. Note that the material of the natural note keys 11 and the material of the accidental note keys 12 may differ from each other.

Note that the woody material of which the natural note keys 11 and accidental note keys 12 are made may be offcuts generated when various wooden products, for example, musical instruments or building materials, are produced. As described above, making effective use of resources rather than discarding them allows reduction in the burden on the environment and contribution to achievement of sustainable development.

FIG. 5 is a side view of any one of the natural note keys 11. The natural note key 11 is a structure including a base portion 41a, an attachment portion 42a, and a guide portion 43a. The base portion 41a is an elongated basic portion including the first playing surface F1 out of the natural note key 11.

The attachment portion 42a is a portion that attaches the base portion 41a (natural note key 11) to the enclosure 20, and is continuous with the base end (end far from player) of the base portion 41a. The natural note key 11 pivots around a pivotal axis C1 along the X-axis while being supported by the enclosure 20 via the attachment portion 42a, as shown in FIG. 3. The guide portion 43a is a guide that restricts the movement of the natural note key 11 in the X-axis direction. Specifically, the guide portion 43a protrudes vertically downward from the lower surface of the base portion 41a that is opposite the first playing surface F1, as shown in FIGS. 4 and 5.

The keyboard 1 in the first embodiment includes a plurality of key assemblies 50 corresponding to different accidental notes, as shown in FIGS. 3 and 4. One key assembly 50 is disposed between two natural note keys 11 adjacent to each other in the X-axis direction.

FIG. 6 is an exploded side view of any one of the key assemblies 50. One key assembly 50 corresponding to each accidental note includes the aforementioned accidental note key 12 corresponding to the accidental note, and a support 51, which supports the accidental note key 12, as shown in FIGS. 4 and 6.

The support 51 is a structure including a base portion 41b, an attachment portion 42b, and a guide portion 43b, as shown in FIG. 6. The support 51 is formed as an integral part by injection molding of an elastic material, for example, a plastic material. The accidental note key 12 is made of a material containing a woody material, while the support 51 is made of a material containing no woody material.

In the first embodiment, the accidental note key 12 having the texture and characteristics of a woody material is realized by using a material containing the woody material. On the other hand, the support 51, which supports the accidental note key 12, is made of a material containing no woody material. That is, for example, a material suitable for mechanical properties (mechanical strength and elastic properties, for example) required to support the accidental note key 12 can be selected as the material of the support 51. Each of the keys 10 (key assemblies 50) having the texture and characteristics of the woody material can be realized with the necessary mechanical properties maintained, as described above.

The base portion 41b shown in FIG. 6 supports the accidental note ley 12. The base portion 41b is a basic portion elongated in the Y-axis direction out of the support 51. A rectangular opening 52 elongated in the Y-axis direction is formed through the upper surface of the base portion 41b. A protrusion 13 elongated in the Y-axis direction is formed at the lower surface of the accidental note key 12. The protrusion 13 of the accidental note key 12 is fitted into the opening 52 of the base portion 41b, so that the accidental note key 12 is fixed to the base portion 41b. That is, the outer circumferential surface of the protrusion 13 of the accidental note key 12 is in close contact with the inner circumferential surface of the opening 52 of the base portion 41b. Note that the accidental note key 12 may be fixed to the base portion 41b via a bonding material such as an adhesive or a fastener such as a screw.

The attachment portion 42b is a portion that attaches the base portion 41b (also accidental note key 12) to the enclosure 20, and is continuous with the base end (end far from player) of the base portion 41b. The accidental note key 12 pivots around a pivotal axis C2 along the X-axis while being supported by the enclosure 20 via the attachment portion 42b, as shown in FIG. 3. The guide portion 43b is a guide that restricts the movement of the accidental note key 12 in the X-axis direction. Specifically, the guide portion 43b protrudes vertically downward from the lower surface of the base portion 41b that is opposite the second playing surface F2.

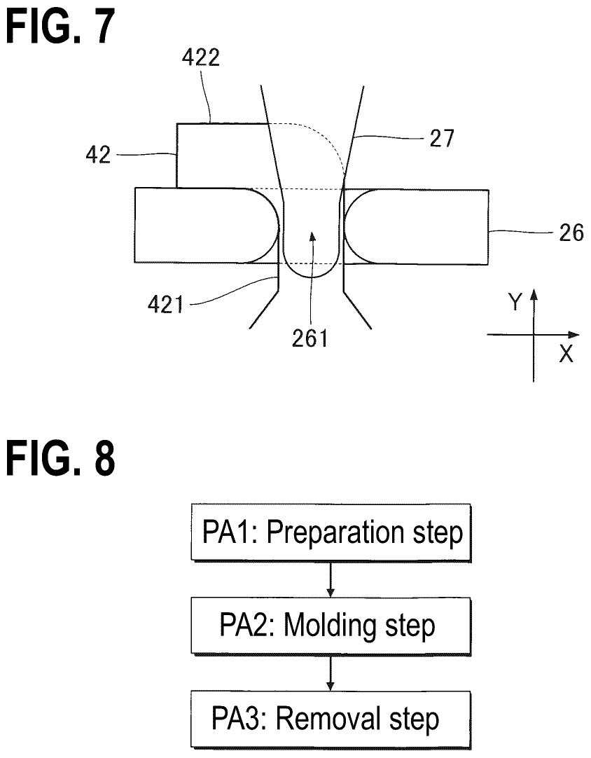

FIG. 7 is an enlarged plan view of an attachment portion 42 (42a, 42b) and the vicinity thereof, the attachment portion 42 corresponding to each of the natural note keys 11 and the accidental note keys 12. The attachment portion 42 is formed of a shaft portion 421 extending in the Y-axis direction from the base end of a base portion 41 (41a, 41b), and a hook portion 422 bent in the X-axis direction from the shaft portion 421. The attachment portion 42 is placed at a bearing 26 and a holder 27, which are disposed in the enclosure 20, so that the corresponding key 10 (adjacent natural note keys 11 and accidental note key 12) is supported by the enclosure 20.

The bearing 26 is a portion extending in the X-axis direction. An attachment groove 261, which opens vertically upward, is formed in the bearing 26. The holder 27 is a portion located vertically above the attachment groove 261. The shaft portion 421 of the attachment portion 42 is inserted into the space surrounded by the inner wall surface of the attachment groove 261 and the lower surface of the holder 27, so that the base portion 41 is supported by the bearing 26.

In the configuration described above, any of the natural note keys 11 pivots around the pivotal axis C1 along the X-axis in response to the player's operation performed on the first playing surface F1. Similarly, any of the accidental note keys 12 pivots around the pivotal axis C2 along the X-axis in response to the player's operation performed on the second playing surface F2. Specifically, with the attachment portion 42 being in contact with the inner wall surface of the attachment groove 261 of the bearing 26 and the lower surface of the holder 27, the tip of the key 10 is displaced in the vertical direction. As can be understood from the above description, the attachment portion 42 is a sliding portion that slides relative to the other members (that is, bearing 26 and holder 27) in conjunction with the displacement of the key 10. A lubricant such as grease or oil is applied to the space between the attachment portion 42 and the bearing 26.

A slit 44 linearly extending in the vertical direction are formed in a guide portion 43 (43a and 43b) corresponding to each of the natural note keys 11 and accidental note keys 12, as shown in FIG. 4. In the enclosure 20 (lower member 22, for example), a flat-plate-shaped restrictor 28, which is inserted into the slit 44 of the guide portion 43, is provided for each of the keys 10, as shown in FIGS. 5 and 6. With the inner wall surface of the slit 44 being in contact with the restrictor 28, the tip of each of the keys 10 is displaced in the vertical direction. The displacement of each of the keys 10 in the X-axis direction is therefore restricted. As can be understood from the above description, the guide portion 43 of each of the keys 10 is a sliding portion that slides relative to the other member (that is, restrictor 28) in conjunction with the displacement of the key 10. A lubricant such as grease or oil is applied to the space between the guide portion 43 and the restrictor 28.

The accidental note keys 12 are made of a material containing a woody material. Therefore, when the lubricant adheres to the accidental note keys 12, there is a possibility of absorption of the lubricant into the accidental note keys 12. In the first embodiment, the sliding portions (attachment portion 42b and guide portion 43b) of each of the key assemblies 50 that slide relative to the other members is realized by the support 51, which contains no woody material. According to the embodiment described above, the possibility of the lubricant adhering to the accidental note keys 12 is reduced. The absorption of the lubricant into the accidental note keys 12 can therefore be suppressed.

FIG. 8 is a flowchart of the step of producing the natural note keys 11 out of the step of producing the keyboard instrument 100. First, in a preparation step Pa1, a composite material (WPC: wood-plastic composite), which is a mixture of a woody material of a specific species of tree and a plastic material, is prepared. Specifically, a high-filling-rate WPC having a woody material content (weight ratio) of 70% or higher is prepared in the preparation step Pa1. For example, the composite material contains a woody material that accounts for 70% by weight and a plastic material that accounts for 30% by weight. The mixture ratio between the woody material and the plastic material is, however, not limited to the value shown above by way of example. The composite material may contain substances other than the woody material and the plastic material.

In a molding step Pa2 after the preparation step Pa1 is performed, a molded body that serves as an original form of each of the natural note keys 11 is formed by injection molding of the composite material. Specifically, an injection molding die is filled with the composite material, which is fluid; the composite material is cooled under pressure; the resultant hardened material is taken out from the opened mold. The molded body is thus formed. The outer surface of the molded body is a molded surface formed by the inner wall surface of the injection molding die.

In a removal step Pa3 after the molding step Pa2 is carried out, a portion of the molded surface of the molded body is removed to form the first playing surface F1 of the natural note key 11. That is, the first playing surface F1 is the surface exposed by the removal of a portion of the molded surface. Specifically, the removal of a portion of the molded surface in the removal step Pa3 is achieved by a cutting-off (cutting) step using a cutting tool such as a blade, a grinding step using a grinding tool such as a metal file or sandpaper, or a polishing (buffing) step using a polishing tool such as a cloth buff.

As described above, the first playing surface F1 of each of the natural note keys 11 is a surface as a result of the removal of a portion of the molded surface of the molded body (hereinafter referred to as the “moisture absorbing surface”). The surfaces of each of the natural note keys 11 excluding the first playing surface F1 are formed of the molded surface of the molded body.

The molded surface of the molded body made of the composite material containing a woody material and a plastic material tends to have a higher plastic content than the inner layer located immediately below the molded surface. The molded surface of the molded body has a higher mechanical strength than the inner layer, and is less hygroscopic than the inner layer having a higher woody material content. The mechanical strength of the natural note keys 11 can therefore be ensured by the surfaces excluding the first playing surface F1. Furthermore, since the surfaces excluding the first playing surface F1 are less hygroscopic, expansion of the natural note keys 11 due to moisture absorption is suppressed.

On the other hand, the surface of the inner layer exposed by the removal of the molded surface is a moisture absorbing surface having a higher woody material content than the molded surface. Moisture adhering to the player's fingers can therefore be absorbed via the moisture absorbing surface. As described above, according to the first embodiment, the molded surface of each of the natural note keys 11 excluding the playing surface maintains the mechanical strength of the natural note key 11 and suppresses expansion thereof due to moisture absorption, while the moisture absorbing surface can absorb moisture adhering to the player's fingers.

The first embodiment, in which the natural note keys 11 are produced from the composite material of a woody material and a plastic material, allows reduction in the amount of the plastic material used in the production as compared with related-art technologies in which the natural note key 11 are molded by using only a plastic material. The first embodiment therefore further provides an advantage of a reduction in the burden on the environment.

Note that when the lubricant adheres to the first playing surface F1 of any of the natural note keys 11, there is a possibility of absorption of the lubricant into the natural note key 11. In the first embodiment, the surfaces of the sliding portions (attachment portion 42a and guide portion 43a) of each of the natural note keys 11 that slide relative to the other members are each the molded surface. Since the molded surface is less hygroscopic than the first playing surface F1, the absorption of the lubricant into the natural note key 11 is suppressed.

In the first embodiment, the first playing surface F1 is formed by the removal of a portion of the molded surface of the molded body. The first playing surface F1, which is effectively capable of absorbing moisture adhering to the player's fingers, can therefore be more readily formed than in an embodiment in which a moisture absorbing layer is additionally formed at the surface of the molded body.

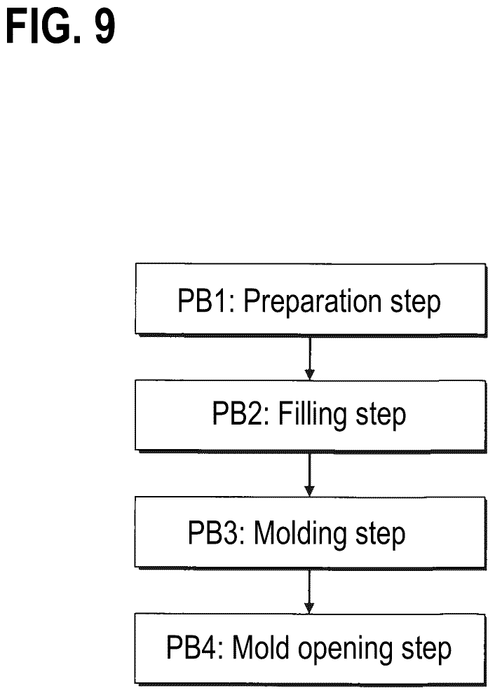

FIG. 9 is a flowchart of the step of producing the accidental note keys 12 out of the step of producing the keyboard instrument 100. First, in a preparation step Pb1, a molding material is prepared. The molding material is a woody material softened by impregnation of the woody material with a liquid chemical such as a resin material. The woody material content of the molding material of the accidental note keys 12 is higher than the woody material content of the composite material used to mold the natural note keys 11.

In a filling step Pb2 after the preparation step Pb1 is carried out, a flow molding die is filled with the molding material. In a molding step Pb3 after the filling step Pb2 is carried out, flow molding is performed. Specifically, the molding material is caused to flow by application of heat and pressure to the interior of the flow molding die, so that the accidental note key 12 corresponding to the internal shape of the flow molding die is molded. In a mold opening step Pb4 after the molding step Pb3 is carried out, the accidental note key 12 is taken out form the opened flow molding die and completed.

The natural note keys 11 produced by the step illustrated in FIG. 8 and the accidental note keys 12 produced by the step illustrated in FIG. 9 are combined with each other into the keyboard 1, and the keyboard 1 is incorporated in the support 2 to produce the keyboard instrument 100.

A second embodiment will be described. Note in each of the following exemplary embodiments that elements having the same functions as those in the first embodiment have the same reference characters as those used in the description of the first embodiment, and detailed descriptions of the same elements will be omitted as appropriate.

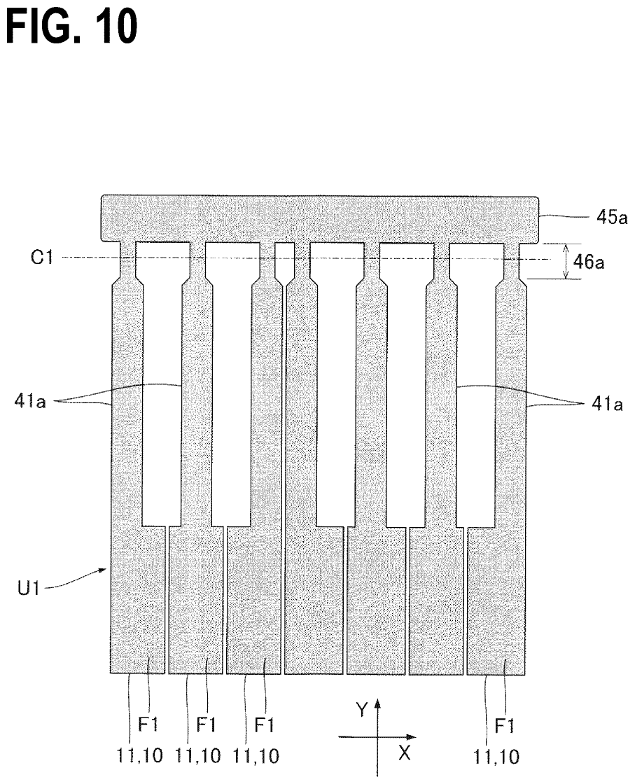

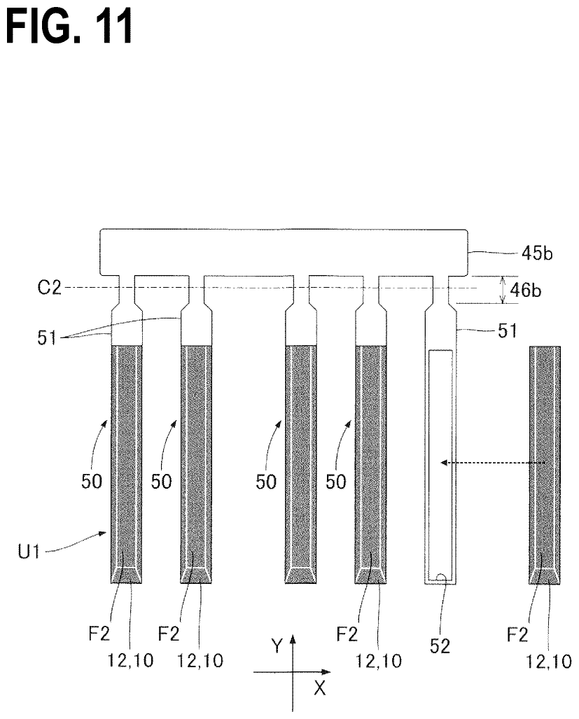

FIGS. 10 and 11 are plan views of a keyboard 1 in the second embodiment. The keyboard 1 in the second embodiment includes a natural note key unit U1 shown in FIG. 10, and an accidental note key unit U2 shown in FIG. 11. The keyboard 1 has a configuration in which a plurality of natural note key units U1 and a plurality accidental note key units U2 are arranged in the X-axis direction.

Each of the natural note key units U1 includes a predetermined number (seven, for example) of natural note keys 11 provided in the keyboard 1, and one linkage member 45a, as shown in FIG. 10. The linkage member 45a is a plate-shaped member elongated in the X-axis direction. The natural note keys 11 and the linkage member 45a are molded in the form of an integral unit, for example, by injection molding using an injection molding die (molding step Pa2). The linkage member 45a is therefore formed along with the plurality of natural note keys 11 by using a woody-plastic-material composite material (WPC).

Each of the natural note keys 11 has a structure in which the attachment portion 42a in the first embodiment is replaced with a deformation portion 46a. That is, each of the natural note keys 11 includes the base portion 41a, the guide portion 43a, and the deformation portion 46a. The structures of the base portion 41a and the guide portion 43a are the same as those in the first embodiment.

The deformation portion 46a of each of the natural note keys 11 is a portion that constitutes an end portion of the natural note key 11, and is linked to the linkage member 45a. That is, the base portion 41a of each of the natural note keys 11 and the linkage member 45a are linked to each other via the deformation portion 46a. The deformation portion 46a is formed thinner than the base portion 41a and can be elastically deformed. That is, the deformation portion 46a elastically deforms in conjunction with the displacement of the natural note key 11 (base portion 41a) caused by the player's playing. Each of the natural note keys 11 pivots around the pivotal axis C1 via the deformation portion 46a.

Each of the accidental note key units U2 includes a predetermined number (five, for example) of the key assemblies 50 out of the plurality of key assemblies 50 provided in the keyboard 1, and one linkage member 45b, as shown in FIG. 11. The linkage member 45b is a plate-shaped member elongated in the X-axis direction. Each of the key assemblies 50 is formed of the accidental note key 12 and the support 51, as in the first embodiment. The supports 51 of the key assemblies 50 and the linkage member 45b are formed as an integral part by injection molding of an elastic material, for example, a plastic material. Note that the color of the natural note keys 11 and the color of the accidental note keys 12 are similar to each other, as in the first embodiment. The second embodiment therefore also provides the same advantages as the first embodiment.

Each of the supports 51 has a structure in which the attachment portion 42b in the first embodiment is replaced with a deformation portion 46b. That is, each of the supports 51 includes the base portion 41b, the guide portion 43b, and the deformation portion 46b. The structures of the base portion 41b and the guide portion 43b are the same as those in the first embodiment. The structure in which the accidental note keys 12 are fixed to the base portions 41b is also the same as that in the first embodiment.

The deformation portion 46b of each of the supports 51 is a portion that constitutes an end portion of the key assembly 50, and is linked to the linkage member 45b. That is, the deformation portions 46b of each of the plurality of key assemblies 50 is linked to the single linkage member 45b. The base portion 41b of each of the supports 51 is linked to the linkage member 45b via the deformation portion 46b.

The deformation portion 46b is formed thinner than the base portion 41b and can be elastically deformed. That is, the deformation portion 46b is elastically deformed in conjunction with the displacement of the accidental note key 12 (base portion 41b) caused by the player's playing. Specifically, each of the accidental note keys 12 pivots around the pivotal axis C2 via the deformation portion 46b.

The configuration in which a portion of each of the accidental note keys 12 made of a woody material is used as the deformation portion 46b may lead to damage to the accidental note key 12 due to repeated elastic deformation. In the second embodiment, a portion of each of the supports 51 made of a material containing no woody material is elastically deformed as the deformation portion 46b. The damage to the accidental note key 12 caused by the elastic deformation in conjunction with the player's playing can therefore be suppressed.

In the second embodiment, the deformation portions 46a of some of the plurality of natural note keys 11 are linked to the common linkage member 45a to form an integral unit. The plurality of natural note keys 11 are therefore readily installed as compared with the configuration in which the plurality of natural note keys 11 are separate from each other. Furthermore, in the second embodiment, the deformation portions 46b of some of the plurality of key assemblies 50 are linked to the common linkage member 45b to form an integral unit. The plurality of key assemblies 50 are therefore readily installed as compared with the configuration in which the plurality of key assemblies 50 are separate from each other.

Aspects of specific variations added to each of the embodiments shown above will be shown below. Two or more of the aspects freely selected from the following examples may be combined with each other as appropriate to the extent that the selected aspects do not contradict each other.

(1) In each of the embodiments described above, the condition for the color difference ΔE*ab between the natural note keys 11 and the accidental note keys 12 (hereinafter referred to as “first condition”) has been described, but attention may instead be paid to a hue difference ΔH* between the natural note keys 11 and the accidental note keys 12. Specifically, the colorimetric values of the natural note keys 11 and the accidental note keys 12 measured based on the SCI method specified by the CIE in the L*a*b* color space may satisfy a condition ΔH*<15° and −1.7<L*/c*<1.7 (hereinafter referred to as “second condition”). More specifically, the condition for the hue difference ΔH* in the second condition is ΔH*<10°.

The measured colorimetric values described above are values measured by using the CM-700d spectrophotometer manufactured by Konica Minolta, Inc. (registered trademark) and the CIE standard light source D65 under the condition d (di:) 8° using diffused illumination (integrating sphere), as in the colorimetry in each of the embodiments described above.

The hue difference ΔH* between the color tone values (WL, Wa, and Wb) of the natural note keys 11 and the color tone values (BL, Ba, and Bb) of the accidental note keys 12 is defined, for example, by the following numerical expression (2): ΔH*=abs {atan (Wb/Wa) atan (Bb/Ba)}× 180/pi ( ) (2)

Note in Expression (2) that atan means arctangent (arctan), and that abs means the absolute value. The symbol pi ( ) represents the ratio of a circle's circumference to its diameter (x). Note, however, that whether the sign of pi ( ) is positive or negative is set in accordance with the value of atan ( ) differently in the following two cases: when the coordinates (a, b) are in the first or fourth quadrant; and when the coordinates (a, b) are in the second or third quadrant.

The term L*/c* in the second condition is defined by the following numerical expressions (3a) and (3b):

$$Natural note keys 11 : {L}^{*} / {c}^{*} = WL / \{ {( {Wa}^{2} + {Wb}^{2} )}^{1 / 2} \} \qquad ( 3 a )$$

$$Accidental note keys 12 : {L}^{*} / {c}^{*} = BL / \{ {( {Ba}^{2} + {Bb}^{2} )}^{1 / 2} \} \qquad ( 3 b )$$

The condition-1.7<L*/c*<1.7 in the second condition holds for both the natural note keys 11 and the accidental note keys 12.

The above second condition for the hue difference between all of the natural note keys 11 and all of the accidental note keys 12, which constitute the keyboard 1, is satisfied. Note, however, that the second condition may be satisfied for some of the natural note keys 11 and some of the accidental note keys 12, which constitute the keyboard 1.

The second condition described above may be satisfied along with the first condition in the first embodiment, or only one of the conditions may be satisfied. Furthermore, in an embodiment in which the condition for the hue difference ΔH*<15° (or ΔH*<) 10° is satisfied, the condition for the reflectance ΔE*ab ≥1 (ΔE*ab ≥2) may or may not be satisfied.

In the variation shown above, the hue difference between the first playing surfaces F1 of the natural note keys 11 and the second playing surfaces F2 of the accidental note keys 12 satisfies ΔH*<15, where ΔH represents a colorimetric value measured based on the SCI method specified in the L*a*b* color space. The sense of color consistency is therefore achieved for the entire plurality of keys 10 (that is, keyboard 1) including the plurality of natural note keys 11 and the plurality of accidental note keys 12, so that an aesthetically excellent design can be provided.

(2) In an embodiment in which the color of the natural note keys 11 and the color of the accidental note keys 12 are similar to each other (ΔE*ab≤17, ΔH*<15), it is also conceivable to employ an embodiment in which the natural note keys 11 and the accidental notes key 12 differ from each other in surface roughness. Specifically, one of the first playing surfaces F1 and the second playing surfaces F2 is formed as a rough surface. For example, a rough surface may be formed at the molded surface of the molded body by making use of irregularities of the inner wall surface of the molding die, or a rough surface may be formed at the molded surface by a surface treatment after the molding.

According to each of the embodiments described above, in which the natural note keys 11 and the accidental note keys 12 differ from each other in optical reflectance, the player can visually distinguish the natural note keys 11 and the accidental note keys 12 from each other. On the other hand, according to the embodiment in which the natural note keys 11 and the accidental note keys 12 differ from each other in surface roughness, the player can tactilely distinguish the natural note keys 11 and the accidental note keys 12 from each other. Note that it is also conceivable to employ an embodiment in which the natural note keys 11 and accidental note keys 12 differ from each other in both optical reflectance and surface roughness. As shown above by way of example, it is conceivable to employ an embodiment in which the first playing surfaces F1 and the second playing surfaces F2 differ from each other in at least one of the optical reflectance and the surface roughness.

(3) Each of the aforementioned embodiments has been presented with reference to the case where the accidental note keys 12 are fixed to the supports 51 made of an elastic material, and the same configuration may also be applied to the natural note keys 11. That is, the natural note keys 11 are formed by flow molding of a woody material of a specific species of tree, and the natural note keys 11 are fixed to supports made of an elastic material containing no woody material, such as a plastic material. That is, the key assemblies are formed of the natural note keys 11 and the supports.

(4) Each of the aforementioned embodiments has been presented with reference to the case where the natural note keys 11 are formed by injection molding of a composite material that is a mixture of a woody material and a plastic material, and the same configuration may also be applied to the accidental note keys 12. That is, for example, the accidental note keys 12 are formed by injection molding of a composite material that is a mixture of a woody material of a specific tree type and a plastic material. The surfaces of each of the accidental note keys 12 excluding the second playing surface F2 are the molded surface of the molded body, and the second playing surface F2 of the accidental note key 12 is a moisture absorbing surface that is a surface of the molded body from which the molded surface is removed. According to the embodiment described above, the moisture absorbing surfaces of the accidental note keys 12 can absorb moisture adhering to the player's fingers, while the mechanical strength of the accidental note keys 12 is maintained and expansion thereof due to moisture absorption is suppressed.

(5) The woody material used to produce the keyboard instrument 100 may have any shape or condition. For example, a woody material in any form or condition, such as wood powder, grains, or chips, may be used to produce the keyboard instrument 100 (keys 10, for example).

(6) In each of the embodiments described above, the following configurations are presented by way of example: Configuration A: The natural note keys 11 and the accidental note keys 12 are similar to each other in terms of color, but differ from each other in optical reflectance or surface roughness; Configuration B: The surfaces of the keys 10 excluding the playing surfaces (F1 and F2) are formed of the molded surfaces of the molded bodies, and the playing surfaces are moisture absorbing surfaces that are surfaces of the molded bodies from which the molded surfaces are removed; and Configuration C: the key assemblies 50 are formed of the keys 10 containing a woody material and the supports 51 containing no woody material.

The configurations A, B, and C are implemented independently of one another. That is, for any of the configurations A to C, the other configurations are not essential and may be omitted. For example, the configuration A is not essential to the configuration B or C, and the natural note keys 11 and the accidental note keys 12 have any relationship in terms of color, optical reflectance, or surface roughness.

(7) The configuration B is also applied to musical instruments other than keyboard instruments. For example, the configuration B may be applied to the fingerboard, which is a portion of a string instrument and is operated by a player to specify pitches. For example, a moisture absorbing surface may be formed at the surface of the fingerboard by removal of a portion of the molded surface of a molded body that forms the original shape of the fingerboard. As can be understood from the example described above, a target to which the configuration B is applied can be comprehensively categorized as musical instruments having a playing portion including a playing surface with which the player comes into contact. The playing portion includes the keys 10 in each of the embodiments described above as well as the fingerboard of a string instrument presented above by way of example.

In each of the embodiments described above, an electronic musical instrument including the sound source apparatus 32 is presented by way of example, and each of the embodiments described above is applicable in the same manner to a natural musical instrument including a sound generation mechanism that generates sound through a mechanical effect. The sound generation mechanism is, for example, a string-striking mechanism of a natural keyboard instrument, or a resonance mechanism formed of strings and a sound body of a natural string instrument.

The present disclosure is also applied to an instrument playing apparatus that do not include the sound source apparatus 32 or the sound generation mechanism. The playing operation apparatus98 is, for example, a musical instrument digital interface (MIDI) controller that accepts a user ‘s operation. The playing operation apparatus is encompassed within the concept of musical instruments (and further, keyboard instruments) in the present disclosure.

From the embodiments presented above by way of example, for example, the following configurations are conceivable:

Various technologies have been proposed in the past with regard to the keys of keyboard instruments, for example, pianos. For example, JP 2011-242792 A discloses a technology for molding a material containing dyed wood powder, resin, and pigment into black keys of a keyboard instrument.

The keyboard of a keyboard instrument has a structure in which a plurality of white keys and a plurality of black keys are arranged. The structure described above is a well-known design, and has room for improvement from various perspectives, for example, the sense of color consistency. In consideration of the circumstances described above, an object of one aspect (Additional Remark A) of the present disclosure is to provide an aesthetically excellent design for a keyboard instrument.

A keyboard instrument according to an aspect (Additional Remark A1) of the present disclosure includes a plurality of keys containing a woody material, the plurality of keys including: a plurality of natural note keys each including a first playing surface configured to be played to produce a natural note; and a plurality of accidental note keys each including a second playing surface configured to be played to produce an accidental note. The first playing surface has a first colorimetric value representing a first color and the second playing surface color has a second colorimetric value representing a second color, each of the first and second colorimetric values being derived in accordance with a specular component included (SCI) method in an L*a*b* color space. The colorimetric value of the first playing surface and the colorimetric value of the second playing surface satisfy at least one of a first condition: ΔΕ* ab<17, and a second condition: ΔH*<15 and −1.7<L*/c*<1.7.

The first playing surface and the second playing surface differ from each other in at least one of optical reflectance or surface roughness.

According to the aspect described above, the first playing surface of each of the natural note keys and the second playing surface of each of the accidental note keys each have a colorimetric value derived in accordance with the SCI method in the L*a*b* color space, the first colorimetric value of the first playing surface and the second colorimetric value of the second playing surface satisfy at least one of: the first condition: (ΔE* ab≤17), and the second condition (ΔH*<15 and −1.7<L*/c*<1.7). The sense of color consistency is therefore achieved for the entirety of the plurality of keys (that is, keyboard) including the plurality of natural note keys and the plurality of accidental note keys, so that an aesthetically excellent design can be provided. However, the first playing surfaces and the second playing surfaces differ from each other in at least one of optical reflectance or surface roughness, so that the player can visually or tactilely distinguish the natural note keys and the accidental note keys from each other. Note that in more specific aspect, the first playing surfaces and the second playing surfaces may each have a colorimetric value derived in accordance with the SCI method in the L*a*b* color space, the colorimetric value of the first playing surfaces and the colorimetric value of the second playing surfaces satisfying ΔE* ab≤12 (first condition), or ΔH*<10 (second condition).

The “natural notes” are the basic musical notes on the musical scale, specifically, refer to musical notes to which accidentals such as sharp or flat are added. Each of the “natural note keys” is a key played to produce a natural note. The “accidental notes” are musical notes other than the natural notes on the musical scale, specifically, musical notes to which accidentals are added. Each of the “accidental note keys” is a key played to produce an accidental note. Each of the “(first/second) playing surfaces” is an exterior surface with which the player of the keyboard instrument comes into contact to play a musical note. The first playing surface and the second playing surface only need to satisfy at least one the first condition and the second condition, and the portions of each of the natural note keys excluding the first playing surface and the portions of each of the accidental note keys excluding the second playing surface have any relationship in terms of color. Similarly, the portions of each of the natural note keys excluding the first playing surface and the portions of each of the accidental note keys excluding the second playing surface may differ from each other in optical reflectance or surface roughness.

In a specific example (Additional Remark A2) of Additional Remark A1, a material that determines the first color of each of the first playing surfaces is identical to a material that determines the second color of each of the second playing surfaces. According to the aspect described above, the material of the first playing surface of each of the natural note keys is identical to the material of the second playing surface of each of the accidental note keys. The natural note keys and the accidental note keys therefore readily have a unified color, as compared with an embodiment in which the first playing surfaces and the second playing surfaces are made of completely different materials. Note that “the material that determines the color of the (first/second) playing surface” is a material that most dominantly contributes to the color of the playing surface (woody material, for example).

In a specific example (Additional Remark A3) of Additional Remark A2, the first playing surface and the second playing surface contain the woody material, which is of an identical species of tree. In the aspect described above, since the material of the first playing surface and the material of the second playing surface contain a material of the identical species of tree, the first playing surface and the second playing surface are readily allowed to have colors close to each other.

In a specific example (Additional Remark A4) of any of Additional Remark A1 to Additional Remark A3, each of the natural note keys is a molded body made of a composite material that is a mixture of a woody material of a specific species of tree and a plastic material, and each of the accidental keys is a molded body made of the woody material of the specific species of tree. According to the aspect described above, the natural note keys and the accidental note keys having colors similar to each other can be formed in a simple step.

The “molded body” is a member formed by molding a material containing a woody material. Examples of a method of forming a molded body (molding method) may include injection molding in which an injection molding die is filled with a material and the material is hardened, flow molding in which a woody material softened by impregnation of the woody material with a chemical is heated and pressured, and extrusion molding in which a material with which a molding die is filled is extruded via an extrusion port (die) and hardened. In addition to the examples described above, various molding technologies, such as transfer molding and compression molding, are used to form a molded body.

For example, each of the natural note keys is an injection molded body formed by injection molding of a composite material that is a mixture of a woody material of a specific species of tree and a plastic material. Each of the accidental note keys is, for example, a flow molded body formed by flow molding of a composite material that is a mixture of a woody material of a specific species of tree and a plastic material.

In a specific example (Additional Remark A5) of any of Additional Remark A1 to Additional Remark A4, the first playing surface has a third colorimetric value and the second playing surface has a fourth colorimetric value, each of the third and fourth colorimetric values being derived in accordance with a specular component excluded (SCE) method in the L*, the colorimetric value of the first playing surface and the colorimetric value of the second playing surface satisfying ΔE* ab ≥1. According to the aspect described above, the player can visually distinguish the natural note keys and the accidental note keys from each other. Note that in more specific aspect, the first playing surface and the second playing surface each have a colorimetric value derived in accordance with the SCE method in the L*a*b* color space, the colorimetric value of the first playing surface and the colorimetric value of the second playing surface satisfying ΔE* ab ≥2.

Various technologies have been proposed in the past with regard to the keys of keyboard instruments, for example, pianos. For example, Japanese Published Unexamined Patent Application No. S51-108821 discloses a technology for molding a material that is a mixture of powder of a hard organic material and a phenol resin into a keyboard.

Moisture such as sweat on the player ‘s fingers adhering to the surfaces of the keys causes a problem of slippery surfaces that cause the player's fingers to slip during the player's playing. Keys made of a hygroscopic material mitigates the problem described above. When priority is given to the hygroscopicity, however, it is difficult to maintain the mechanical strength of the keys. In view of the circumstances described above, an object of an aspect (Additional Remark B) of the present disclosure is to avoid a situation in which moisture adhering to the keys hinders the player's playing while maintaining the mechanical strength of the keys.

A musical instrument according to an aspect (Additional Remark B1) of the present disclosure includes a playing portion including a playing surface with which a player comes into contact, the playing portion being a molded body made of a composite material containing a woody material and a plastic material, surfaces of the playing portion excluding the first playing surface are each formed of a molded surface, and the playing surface being a moisture absorbing surface formed as a result of removal of the molded surface from the molded body.

The molded surface of the molded body made of the composite material containing a woody material and a plastic material tends to have a higher plastic content than the inner layer located immediately below the molded surface. The molded surface of the molded body has a higher mechanical strength than the inner layer, and is less hygroscopic than the inner layer having a higher woody material content. The mechanical strength of the playing portion can therefore be ensured by the surfaces excluding the playing surface. Furthermore, since the surfaces excluding the playing surface are less hygroscopic, expansion of the playing portion due to moisture absorption is suppressed. On the other hand, the surface of the inner layer exposed by the removal of the molded surface is a moisture absorbing surface having a higher woody material content than the molded surface. Moisture adhering to the player's fingers can therefore be absorbed via the moisture absorbing surface. As described above, according to the first embodiment, the molded surface of the playing portion excluding the playing surface maintains the mechanical strength of the playing portion and suppresses expansion thereof due to moisture absorption, while the moisture absorbing surface can absorb moisture adhering to the player's fingers. Furthermore, the surface of the inner layer exposed by the removal of the molded surface excels in feel as compared with the molded surface, so that a favorable contact sound is produced when the player's finger comes into contact with the surface. That is, a favorable playing sensation can be achieved as compared with an embodiment in which the playing surface is formed of the molded surface.

The “playing surface” is an exterior surface of a musical instrument with which the player comes into contact to perform playing, and the “playing portion” is a portion of the musical instrument that includes the playing surface. A typical example of the playing portion is each of the keys of a keyboard instrument. The upper surface of the key that is played by the player to produce a musical note corresponds to the “playing surface”. The playing portion is, however, not limited to the key. Other examples of the “playing portion” may include a fingerboard of a string instrument that is played by the player to specify a pitch, the main body of an idiophone with which the player comes into contact, such as castanets, and an operator of various musical instruments that controls a musical note (hereinafter referred to as “musical note control operator”).

In the form of musical note control operator, the “playing portion” is a stick for a drum including an electronic drum, or various operators that adjust the pitch, volume, or other musical note characteristics (wheel joystick, ribbon sensor, assignable lever, or portamento bar). For example, the portamento bar is an elongated operator placed along the keyboard of a keyboard instrument. The player can continuously change the pitch during sound generation by moving the player's fingers rightward or leftward with the player's fingers being in contact with the surface of the portamento bar. The embodiment described above in which the moisture absorbing surface formed as a result of the removal of the molded surface from the molded body is used as the playing surface allows stable, smooth tracing actions to provide an advantage of improvement in playing quality because the friction between the player's fingers and the portamento bar is hardly affected by the player's sweating state.

The “molded surface” is a surface of the molded body that is the surface formed when the molded body comes into contact with a molding tool. For example, in injection molding, a surface formed by the inner wall surface of an injection molding die (that is, transferred surface) is the “molded surface”, and in flow molding, a surface formed by the inner wall surface of a flow molding die (that is, transferred surface) is the “molded surface”. In extrusion molding, a surface formed by the inner wall surface of an extrusion port (that is, surface extending in extrusion direction) is the “molded surface”.

In a specific example (Additional Remark B2) of Additional Remark B1, the playing portion is a key with which the player comes into contact to produce a musical note. In the aspect described above, the moisture absorbing surface containing a woody material constitutes the playing surface of the key. The playing surface can therefore effectively absorb moisture such as sweat adhering to the fingers of the player of the keyboard instrument.

A method of producing a musical instrument according to an aspect (Additional Remark B3) of the present disclosure includes forming a molded body from a composite material containing a woody material and a plastic material, and removing a portion of a molded surface of the molded body to form a playing surface of the musical instrument, the playing surface being for a player to come into contact with. In the aspect described above, the playing surface is formed by the removal of a portion of the molded surface of the molded body. The playing surface, which is effectively capable of absorbing moisture such as sweat adhering to the player's fingers, can therefore be more readily formed than in an embodiment in which a moisture absorbing layer is formed at the surface of the molded body.

Any method of removing the molded surface may be employed. For example, the removal of the molded surface is achieved by a cutting-off (cutting) step using a cutting tool such as a blade, a grinding step using a grinding tool such as a metal file or sandpaper, or a polishing (buffing) step using a polishing agent and a polishing tool such as a cloth buff. The molded surface may instead be removed by a surface treatment, for example, skinning, sliding, or filtering.

Various technologies have been proposed in the past with regard to the keys of keyboard instruments, for example, pianos. For example, JP 2011-242792 A discloses a technology for molding black keys of a keyboard instrument from a material containing dyed wood powder, resin, and pigment.

The technology disclosed in JP 2011-242792 A allows formation of keys having the texture and characteristics of a woody material, but it is also important to ensure mechanical characteristics of the keys of a keyboard instrument, such as the relationship between the key pressing force applied by the player and the displacement of the key. In view of the circumstances described above, an object of an aspect (Additional Remark C) of the present disclosure is to achieve keys having the texture and characteristics of a woody material while maintaining the mechanical characteristics required for the keys.

A keyboard instrument according to an aspect (Additional Remark C1) of the present disclosure is a keyboard instrument including a plurality of key assemblies, the plurality of key assemblies each having a playing surface played to produce a musical note, and including a key made of a material containing a woody material and a support made of a material containing no woody material and supporting the key. In the aspect described above, a key having the texture and characteristics of a woody material is realized by using the material containing the woody material. On the other hand, the support is made of the material containing no woody material. That is, for example, a material suitable for mechanical properties required to support a key can be selected as the material of the support. A key having the texture and characteristics of the woody material can be realized while the mechanical properties required to support the key are maintained, as described above.

In a specific example (Additional Remark C2) of Additional Remark C1, the support includes a sliding portion configured to slide relative to another member in conjunction with displacement of the key. The key is made of the material containing the woody material. Therefore, when a lubricant adheres to the key, there is a possibility of absorption of the lubricant into the key. According to the embodiment in which the sliding portion, which slides relative to another member, is achieved by the support containing no woody material, the possibility of absorption of the lubricant into the key is reduced. The absorption of the lubricant into the key can therefore be suppressed.

In a specific example (Additional Remark C3) of Additional Remark C1 or Additional Remark C2, the support includes a deformation portion elastically deformed in conjunction with displacement of the key. The key is made of the material containing the woody material and may therefore be damaged due to repeated elastic deformation. According to the embodiment in which the support made of the material containing no woody material includes the deformation portion, the damage to the key due to the elastic deformation can be suppressed.

In a specific example (Additional Remark C4) of Additional Remark C3, the deformation portion of each of the plurality of key assemblies is linked to a single linkage member. In the aspect described above, the deformation portion of each of the plurality of key assemblies is linked to a common linkage member. The plurality of keys are therefore readily installed as compared with an embodiment in which the plurality of key assemblies are separate from each other.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A keyboard instrument comprising:
a plurality of keys containing a woody material, the plurality of keys including:
a plurality of natural note keys each including a first playing surface configured to be played to produce a natural note; and
a plurality of accidental note keys each including a second playing surface configured to be played to produce an accidental note,
wherein the first playing surface has a first colorimetric value representing a first color and the second playing surface color has a second colorimetric value representing a second color, each of the first and second colorimetric values being derived in accordance with a specular component included (SCI) method in an L*a*b* color space,
wherein the first colorimetric value of the first playing surface and the second colorimetric value of the second playing surface satisfy at least one of:
$$a first condition : Δ {E}^{*} ab \leq 17 , or$$
$$a second condition : Δ {H}^{*} < 15 and - 1.7 < {L}^{*} / {c}^{*} < 1.7 ,$$
where ΔE*ab represents a color difference between the first color and the second color, ΔH* represents a hue difference between the first color and the second color, and L*/c* represents
$$WL / \{ {( {Wa}^{2} + {Wb}^{2} )}^{1 / 2} \} , or$$
$$BL / \{ {( {Ba}^{2} + {Bb}^{2} )}^{1 / 2} \}$$
where WL, Wa, and Wb represent color tone values of the plurality of natural note keys, and BL, Ba, and Bb represent color tone values of the plurality of accidental note keys, and
wherein the first playing surface and the second playing surface differ from each other in at least one of optical reflectance or surface roughness.

2. The keyboard instrument according to claim 1, wherein a material that determines the first color of each of the first playing surfaces is identical to a material that determines the second color of each of the second playing surfaces.

3. The keyboard instrument according to claim 2, wherein the first playing surface and the second playing surface contain the woody material, which is of an identical species of tree.

4. The keyboard instrument according to claim 1, wherein:
each of the plurality of natural note keys is a molded body made of a composite material that is a mixture of the woody material, which is of a specific species of tree, and a plastic material; and
each of the plurality of accidental keys is a molded body made of the woody material, which is of the specific species of tree.

5. The keyboard instrument according to claim 1, wherein:
the first playing surface has a third colorimetric value and the second playing surface has a fourth colorimetric value, each of the third and fourth colorimetric values being derived in accordance with a specular component excluded (SCE) method in the L*; and
the third colorimetric value of the first playing surface and the fourth colorimetric value of the second playing surface satisfying ΔE*ab ≥1.

6. The keyboard instrument according to claim 1, wherein:
surfaces of each of the natural note keys, excluding the first playing surface are each formed of a molded surface of a molded body made of a composite material that is a mixture of the woody material, which is of a specific species of tree, and a plastic; and
the first playing surface is a moisture absorbing surface formed as a result of removal of the molded surface from the molded body.

7. The keyboard instrument according to claim 1, further comprising a plurality of key assemblies each including:
the accidental note key made of a material containing the woody material; and
a support that is made of a material that contains no woody material and supports the accidental note key.

8. The keyboard instrument according to claim 7, wherein the support includes a sliding portion configured to slide relative to another member in conjunction with displacement of the accidental note key.

9. The keyboard instrument according to claim 7, wherein
the support includes a deformation portion configured to elastically deform in conjunction with displacement of the accidental note key.

10. The keyboard instrument according to claim 9, wherein
the deformation portion of each of the plurality of key assemblies is linked to a single linkage member.

11. A method of producing a key of a keyboard instrument, the method comprising:
forming a molded body from a composite material containing a woody material and a plastic material; and
removing a portion of a molded surface of the molded body to form a playing surface of the key, the playing surface being for a player to come into contact with to produce a musical note.
